(19) United States
(12) Patent Application Publication
(10) Pub. No.: US 2020/0310986 A1
(43) Pub. Date: Oct. 1, 2020

(54) DATA STORAGE DEVICE AND OPERATING METHOD THEREOF, AND STORAGE SYSTEM INCLUDING THE SAME

(71) Applicant: SK hynix Inc., Gyeonggi-do (KR)

(72) Inventor: Hye Mi KANG, Gyeonggi-do (KR)

(21) Appl. No.: 16/598,471

(22) Filed: Oct. 10, 2019

(30) Foreign Application Priority Data
Mar. 25, 2019 (KR) 10-2019-0033711

(51) Int. Cl. G06F 12/123; G06F 12/10

(52) U.S. Cl. CPC G06F 12/124; G06F 2212/1044; G06F 12/10

(57) ABSTRACT

A data storage device may include: a storage; a controller configured to control data input to, and output from, the storage in response to a request from a host device; and a second buffer memory. The controller may include a first buffer memory, and is configured to store write data, provided by the host device, in the first buffer memory in response to a write request of the host device, and move the write data, stored in the first buffer memory, into the second buffer memory or the storage based on an attribute of the write data.

### CROSS-REFERENCE TO RELATED APPLICATION

The present application claims priority under 35 U.S.C. § 119(a) to Korean application number 10-2019-0033711, filed on Mar. 25, 2019, in the Korean Intellectual Property Office, which is incorporated herein by reference in its entirety.

### BACKGROUND

### 1. Technical Field

Various embodiments generally relate to a semiconductor integrated device, and more particularly, to a data storage device and an operating method thereof, and a storage system including the same.

### 2. Related Art

A storage device is coupled to a host device and performs a data input/output operation in response to a request from the host device. The storage device may use various storage media in order to store data.

In general, the storage device may be configured and operate so that a read operation has a higher priority and lower latency than a write operation.

A storage device incapable of performing an overwrite operation or an in-place-update operation needs to process a request from a host device by mapping a logical address, provided along with a read/write request from the host device, to a physical address.

A sequential write/read method includes writing data to, or reading data from, a storage space having continuous physical addresses, where the data is of a specific length. The sequential write/read method can support a fast read operation for a storage device because address mapping does not need to be performed on the entire storage space with respect to each item of data read or written.

If some data written using the sequential write method are changed, performance of a storage device may be degraded because the continuity of an address is not guaranteed.

### SUMMARY

In an embodiment, a data storage device may include: a storage; a controller configured to control data input to, and output from, the storage in response to a request from a host device; and a second buffer memory. The controller may include a first buffer memory, and is configured to store write data, provided by the host device, in the first buffer memory in response to a write request of the host device, and move the write data, stored in the first buffer memory, into the second buffer memory or the storage based on an attribute of the write data.

In an embodiment, a data storage device may include a storage, a second buffer memory, and a first buffer memory, and may be configured to include a controller configured to store sequential write data, having a length greater than a preset reference value, in the second buffer memory in response to a write request from a host device and to update the sequential write data within the second buffer memory in response to a request for changing at least some of the sequential write data.

In an embodiment, an operating method of a data storage device is an operating method of a data storage device, including a storage, a second buffer memory, a controller controlling data input to, and output from, the storage in response to a request from a host device, and a first buffer memory, the operating method comprising: storing, by the controller, write data, provided by the host device, in the first buffer memory in response to a write request of the host device, and moving, by the controller, the write data, stored in the first buffer memory, into the second buffer memory or the storage based on an attribute of the write data.

In an embodiment, a data storage device may include: nonvolatile storage; a memory configured to perform an in-place-update operation; and a processor configured to control the nonvolatile storage to store non-sequential write data; and control the memory to cache sequential write data, which is to be stored in the nonvolatile storage, and corresponding logical address information, wherein the processor is further configured to control the memory to update at least some of the sequential write data cached therein based on the cached logical address information and currently write-requested logical address information.

### BRIEF DESCRIPTION OF THE DRAWINGS

FIG. 1 illustrates a configuration of a data storage device according to an embodiment,

FIG. 2 is a diagram illustrating a management concept of a second buffer memory according to an embodiment.

FIG. 3 illustrates a configuration of a controller according to an embodiment.

FIG. 4 illustrates a configuration of a data storage device according to an embodiment.

FIGS. 5 and 6 are flowcharts illustrating an operating method of the data storage device according to an embodiment.

FIG. 7 is a flowchart illustrating an operating method of the data storage device according to an embodiment.

FIG. 8 and FIG. 9 are diagrams illustrating a data storage system in accordance with an embodiment.

FIG. 10 and FIG. 11 are diagrams illustrating a data processing system in accordance with an embodiment.

FIG. 12 is a diagram illustrating a network system including a data storage device in accordance with an embodiment.

FIG. 13 is a block diagram illustrating a nonvolatile memory device included in a data storage device in accordance with an embodiment.

### DETAILED DESCRIPTION

Various embodiments of the present invention are described in more detail below with reference to the accompanying drawings. Throughout the specification, reference to “an embodiment,” “another embodiment” or the like is not necessarily to only one embodiment, and different references to any such phrase are not necessarily to the same embodiment(s).

It will be further understood that the terms “comprises,” “comprising,” “includes,” and “including” when used in this specification, specify the presence of the stated elements and do not preclude the presence or addition of one or more other elements. As used herein, the term “and/or” includes any and all combinations of one or more of the associated listed items.

As used herein, singular forms may include the plural forms as well and vice versa, unless the context clearly indicates otherwise. The articles ‘a’ and ‘an’ as used in this application and the appended claims should generally be construed to mean ‘one or more’ unless specified otherwise or clear from context to be directed to a singular form.

<Data Storage Device>

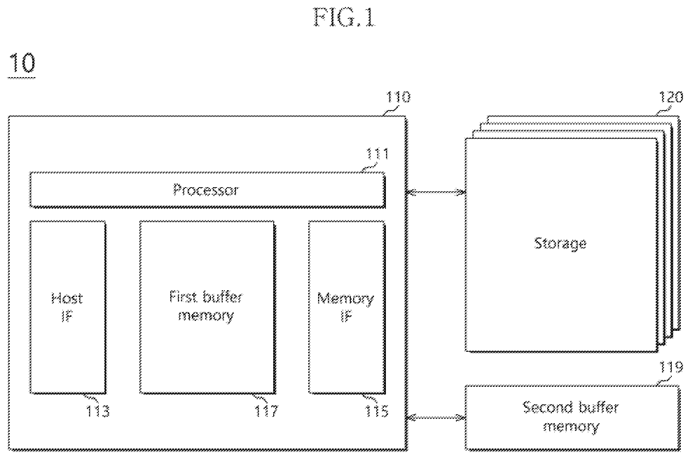

FIG. 1 illustrates a configuration of a data storage device according to an embodiment.

Referring to FIG. 1, the data storage device 10 according to an embodiment may include a controller 110, a storage 120 and a second buffer memory 119.

The controller 110 may control the storage 120 in response to a request from a host device. For example, the controller 110 may control data to be programmed into the storage 120 in response to a program (write) request from a host device. Furthermore, the controller may provide the host device with data written in the storage 120 in response to a write request from the host device.

The storage 120 may write data or output written data under the control of the controller 110. The storage 120 may be configured with a volatile or non-volatile memory device. In an embodiment, the storage 120 may be implemented using any of various non-volatile memory devices, such as an electrically erasable and programmable ROM (EEPROM), a NAND flash memory, a NOR flash memory, a phase-change RAM (PRAM), a resistive RAM (ReRAM), a ferroelectric RAM (FRAM), and/or a spin torque transfer magnetic RAM (STT-MRAM). The storage 120 may include a plurality of dies, or a plurality of chips, or a plurality of packages. Furthermore, the storage 120 may be configured with a single level cell in which data of one bit is stored in a single memory cell or a multi-level cell in which data of plural bits is stored in a single memory cell.

In an embodiment, the storage 120 may be configured with a memory device not supporting overwrite and/or in-place update, but the present invention is not limited thereto.

The controller 110 may include a processor 111, a host interface 113, a memory interface 115 and a first buffer memory 117.

The processor 111 may provide various functions for enabling the controller 110 to manage the storage 120, for example, functions, such as garbage collection, address mapping, and wear leveling. The processor 111 may control the host interface 113, the memory interface 115, the first buffer memory 117 and the second buffer memory 119 so that a write or read command provided by a host device is processed.

In an embodiment, the controller 110 may further include a second buffer memory controller (not illustrated) for controlling an operation of the second buffer memory 119.

The host interface 113 may provide an interface between a host device and the controller 110. The host interface 113 may store and schedule a command provided by the host device, and may provide the command to the processor 111. The host interface 113 may store write data, provided by the host device, in the first buffer memory 117 or provide the host device with read data stored in the first buffer memory 117 under the control of the processor 111.

The memory interface 115 may provide an interface between the storage 120 and the controller 110. The memory interface 115 may transmit write data, stored in the first buffer memory 117, to the storage 120 or store data, read from the storage 120, in the first buffer memory 117 under the control of the processor 111.

The first buffer memory 117 functions as a space capable of temporally storing data when the data storage device 10 performs a series of operations of writing or reading data in association with a host device. FIG. 1 illustrates an example in which the first buffer memory 117 is disposed within the controller 110, but in another embodiment the first buffer memory 117 may be provided externally to the controller 110.

The second buffer memory 119 may function as a space for caching the write data stored in the first buffer memory 117 when the attribute of the write data corresponding to a write request from a host device satisfies a set condition. In an embodiment, the second buffer memory 119 may be configured to cache sequential write data stored in the first buffer memory 117 and to update the sequential write data cached therein in response to a write request.

The processor 111 may segment each of the first and second buffer memories 117 and 119 into a plurality of slots, and may allocate one of empty slots when a data storage event for the first or second buffer memory 117 or 119 occurs. In an embodiment, the second buffer memory 119 may store sequential write data, which has a minimum length. The start logical address and length of the sequential write data may be stored along with the sequential write data in an allocated slot of the second buffer memory 119.

In an embodiment, a host device may transmit write data, and the size (or length) and destination logical address of the write data to the host interface 113 along with a write command. The processor 111 may receive the write command and the size of write data from the host interface 113, and may allocate a slot of the first buffer memory 117. Accordingly, the host interface 113 may store the write data, forwarded by the host device, in the allocated slot of the first buffer memory 117.

The processor 111 may be configured to move data, stored in the first buffer memory 117, to the second buffer memory 119 or the storage 120 based on the attribute of write data, for example, the size (or length) and logical address of the write data.

In order to move data, stored in the first buffer memory 117, to the second buffer memory 119 or the storage 120, the processor 111 may transmit a write or move command to the second buffer memory 119 or the memory interface 115. The second buffer memory 119 or the memory interface 115 may then move write data from the first buffer memory 117 into the second buffer memory 119 or the storage 120, in response to the write command.

In an embodiment, if data moved from the first buffer memory 117 to the second buffer memory 119 satisfies a set condition, the processor 111 may control the memory interface 115 so that the data of the second buffer memory 119 is programmed or flushed into the storage 120. In another aspect, the processor 111 may control the memory interface 115 so that a slot satisfying a set condition is selected among a plurality of slots allocated to the second buffer memory 119 and the write data of the selected slot is programmed into the storage 120.

In an embodiment, a host device may transmit the size (or length) and destination logical address of read data to the host interface 113 along with a read command.

The processor 111 may provide data, read from the storage 120 or the second buffer memory 119, to a host device through the host interface 113 by controlling the memory interface 115 or the second buffer memory 119 based on a read-requested logical address.

<Management of Second Buffer Memory>

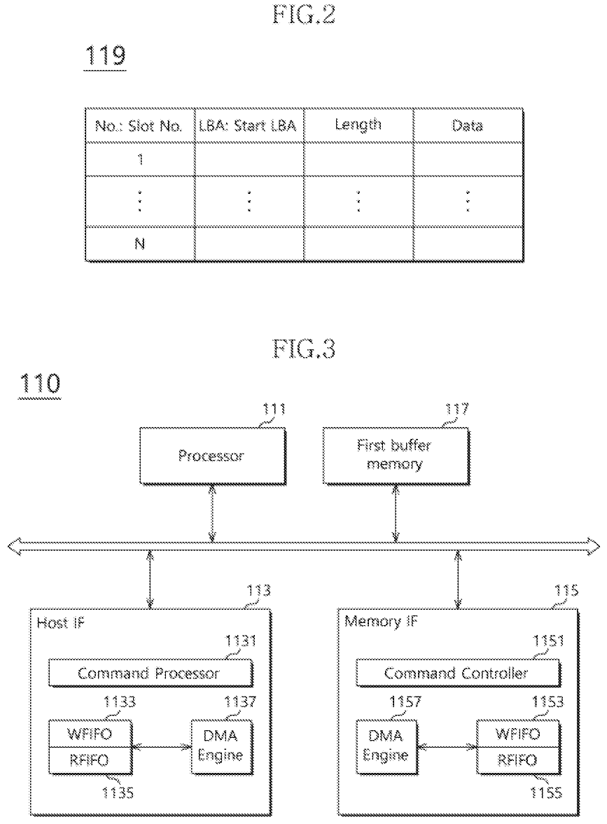

FIG. 2 is a diagram for illustrating a management concept of a second buffer memory according to an embodiment.

Referring to FIG. 2, the controller 110 or a buffer controller (not illustrated) may segment the second buffer memory 119 into a plurality (e.g., N) slots.

If write data stored in the first buffer memory 117 satisfies a set condition, the controller 110 may allocate any one of empty slots in order to store the write data of the first buffer memory 117 in the second buffer memory 119. Furthermore, the controller 110 may store the write data moved from the first buffer memory 117 and a start logical address (start LBA) and a length of the write data in the allocated slot of the second buffer memory 119.

A condition for write data to be moved from the first buffer memory 117 to the second buffer memory 119 may be the length (or size) of the write data. Sequential write data may be stored in the second buffer memory 119. In an embodiment, a condition for the write data to be updated in the second buffer memory 119 may be the logical address of the write data. If a slot caching the logical address of write data for which a write request has been made is present in the second buffer memory 119, the corresponding write data might be already cached in that slot of the second buffer memory 119 and thus may be updated in response to the write request.

In another aspect, if write data has a minimum length or more or write data is to be updated within sequential data previously cached in the second buffer memory 119, the corresponding write data may be cached or updated in the second buffer memory 119.

In an embodiment, the second buffer memory 119 may be implemented using any of various non-volatile memory devices capable of overwrite and in-place update, such as a phase-change RAM (PRAM), a resistive RAM (ReRAM), a ferroelectric RAM (FRAM), and/or a spin torque transfer magnetic RAM (STT-MRAM).

As described above, the data storage device 10 according to an embodiment may include the controller 110 equipped with the first buffer memory 117, the second buffer memory 119 capable of overwrite, and the storage 120.

In an embodiment, the controller 110 may store write data in the first buffer memory 117 in response to a write request from a host device, and may move the write data, stored in the first buffer memory 117, in the second buffer memory 119 or the storage 120 based on the attribute of the write data. In an embodiment, the attribute of the write data may be at least any one of the length and logical address of the write data.

In an embodiment, if write data is of a minimum length or more, the write data may be forwarded from the first buffer memory 117 to the second buffer memory 119.

In an embodiment, if at least some of the logical addresses of current write data are cached in a slot of the second buffer memory 119, the current write data may be updated in the second buffer memory 119.

In an embodiment, if at least some of the logical addresses of write data are included in a slot of the second buffer memory 119, write data of a portion having the same logical address may be overwritten in the second buffer memory 119 so that data of the second buffer memory 119 is updated. Write data of a portion not having the same logical address may be programmed from the first buffer memory 117 to the storage 120.

In another aspect, if write data is sequential write data, the controller 110 may forward the write data from the first buffer memory 117 to the second buffer memory 119, and may program write data cached in the second buffer memory 119 and satisfying a set condition, into the storage 120. In an embodiment, the set condition may be write data satisfying the least recently used (LRU) algorithm, or the number of times that write data has been changed, but the present invention is not limited thereto. Furthermore, as those skilled in the art understand, to program write data from the second buffer memory 119 to the storage 120, the access history of the write data may be stored in the second buffer memory 119 while each item of the write data is retained in the second buffer memory 119.

In another aspect, if current write data is for updating write data previously cached in the second buffer memory 119, the controller 110 may overwrite the already-cached write data in the second buffer memory 119 with the current write data. Furthermore, the controller 110 may program data, cached in the second buffer memory 119 and satisfying a set condition, into the storage 120.

<Controller>

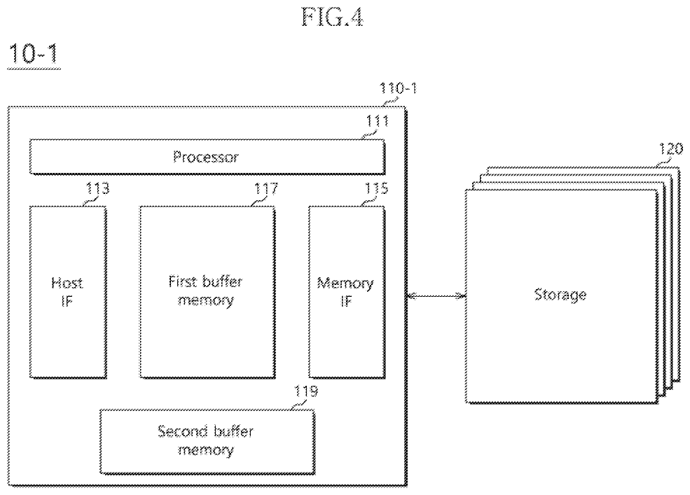

FIG. 3 illustrates a configuration of a controller according to an embodiment.

Referring to FIG. 3, the controller 110 according to an embodiment may include the processor 111, the host interface 113, the memory interface 115 and the first buffer memory 117.

The processor 111 may be configured to forward various types of control information for the read or write operation of data to the host interface 113, the memory interface 115, the first buffer memory 117 and the second buffer memory 119. In an embodiment, the processor 111 may operate according to firmware provided for various operations of the data storage device 10. In an embodiment, the processor 111 may perform the functions of a flash translation layer (FTL) for performing garbage collection, address mapping, and wear leveling for managing the storage 120, and a function for detecting and correcting an error of data read from the storage 120.

The host interface 113 may receive a command and a clock signal from a host device under the control of the processor 111, and may provide a communication channel for controlling the input and output of data. In particular, the host interface 113 may provide a physical connection between a host device and the data storage device 10. Furthermore, the host interface 113 may provide interfacing with the data storage device 10 in accordance with the bus format of a host device. The bus format of the host device may include at least any one of standard interface protocols, such as secure digital, a universal serial bus (USB), a multi-media card (MMC), an embedded MMC (eMMC), personal computer memory card international association (PCMCIA), parallel advanced technology attachment (DATA), serial advanced technology attachment (SATA), a small computer system interface (SCSI), a serial attached SCSI (SAS), peripheral component interconnection (PCI), PCI Expresss (PCI-E), and universal flash storage (UFS).

The host interface 113 may include a command processor 1131, a write buffer (WFIFO) 1133, a read buffer (RFIFO) 1135 and a DMA engine 1137.

The command processor 1131 may queue commands provided by a host device, may schedule the processing sequence of the commands, and may sequentially provide the commands to the processor 111.

The write buffer 1133 may temporally store write data provided by a host device.

The read buffer 1135 may temporally store read data provided by the first buffer memory 117 or the second buffer memory 119.

The DMA engine 1137 may store data, stored in the write buffer 1133, in the first buffer memory 117 by forwarding the data to the first buffer memory 117 when a write operation is performed, and may store data, stored in the first buffer memory 117 or the second buffer memory 119, in the read buffer 1135 by reading the data from the first buffer memory 117 or the second buffer memory 119 when a read operation is performed.

The memory interface 115 may provide a communication channel for signal transmission and reception between the controller 110 and the storage 120. The memory interface 115 may write data, temporarily stored in the first or second buffer memory 117 or 119, in the storage 120 under the control of the processor 111. Furthermore, the memory interface 115 may temporarily store data read from the storage 120 in the first buffer memory 117 by forwarding the data to the first buffer memory 117.

The memory interface 115 may include a command controller 1151, a write buffer (WFIFO) 1153, a read buffer (RFIFO) 1155 and a DMA engine 1157.

The command controller 1151 may transmit a control signal to the storage 120 based on a command provided by the processor 111.

The write buffer 1153 may temporally store write data transmitted by the first buffer memory 117 or the second buffer memory 119 when a write operation is performed.

The read buffer 1155 may temporally store data read from the storage 120 when a read operation is performed.

The DMA engine 1157 may store write data, stored in the first buffer memory 117 or the second buffer memory 119, in the write buffer 1153 by forwarding the write data to the write buffer 1153 when a write operation is performed, and may store read data, stored in the read buffer 1155, in the first buffer memory 117 by forwarding the read data to the first buffer memory 117 when a read operation is performed.

<Write Operation Processing of Processor>

In an embodiment, the processor 111 may be configured to receive a start logical address, length and write data along with a write request from a host device, cache the write data in the first buffer memory 117, and cache the write data, cached in the first buffer memory 117, in the second buffer memory 119 based on a set condition or program the cached write data into the storage 120.

In an embodiment, the processor 111 may allocate a specific slot of the first buffer memory 117 in order to store write data provided along with a write request from a host device. Accordingly the host interface 113 may store the write data in the allocated slot of the first buffer memory 117.

The processor 111 may determine whether the write request is an update request for data cached in the second buffer memory 119 by identifying whether a logical address provided along with the write request of a host device is cached in a slot of the second buffer memory 119.

The processor 111 may determine whether the attribute of write data is sequential write data or random write data, for example, based on the size, e.g., length, of the write data provided along with a write request from a host device.

If the attribute of write data is sequential write data, the processor 111 may control the second buffer memory 119 so that the write data stored in the first buffer memory 117 is forwarded to the second buffer memory 119.

The processor 111 may control the memory interface 115 so that data of write data stored in the first buffer memory 117 or data stored in the second buffer memory 119 and satisfying a set condition, is programmed into the storage 120. Data programmed from the first buffer memory 117 to the storage 120 may be random write data. Data programmed from the second buffer memory 119 to the storage 120 may be the least recently updated data.

In order to program data from the second buffer memory 119 to the storage 120, the processor 111 may select a slot, among a plurality of slots and satisfying a set condition, as a sacrifice slot, if the number of remaining slots of the second buffer memory 119 is less than or equal to threshold or less. Furthermore, the processor 111 may control the memory interface 115 so that the data of the selected sacrifice slot is programmed into the storage 120. In this case, the set condition may be write data satisfying the least recently used (LRU) algorithm or the number of times that write data has been changed, but the present invention is not limited thereto.

In an embodiment, if only some of the logical addresses of write data are identical with a logical address cached in a slot of the second buffer memory 119, the processor 111 may control the memory interface 115 so that write data of the logical address(es) different from the logical address cached in the second buffer memory 119 is programmed from the first buffer memory 117 to the storage 120, and may control the second buffer memory 119 so that write data of the same logical address(es) as the logical address cached in the second buffer memory 119 is moved from the first buffer memory 117 to the second buffer memory 119.

After data is programmed from the first buffer memory 117 or the second buffer memory 119 to the storage 120, the processor 111 may update a map table. As the update of the map table is completed, after the data is programmed from the first buffer memory 117 or the second buffer memory 119 to the storage 120, a corresponding slot of the first buffer memory 117 or the second buffer memory 119 may be released.

In an embodiment, sequential write data having a relatively long length may be changed with it being cached in the second buffer memory 119. Furthermore, it is determined that sequential write data that has not been recently updated is less likely to be changed for a given period in the future, and thus the least recently used sequential write data is programmed into the storage 120. Accordingly, the sequential write data stored in the storage 120 may be read at high speed in a read request from a host device because they have physically continuous addresses.

<Read Operation Processing of Processor>

The processor 111 may receive a start logical address and a length, provided along with a read request from a host device, from the host interface 113, and may search for a logical address stored in a slot of the second buffer memory 119 and may search for a mapping table for the logical address. Furthermore, the processor 111 may be configured to access a physical space in which data to be read has been stored, to read the data, and to provide the read data to the host device based on a result of the search.

Specifically, the processor 111 may search for whether a read-requested logical address from a host device is included in a slot of the second buffer memory 119. Furthermore, the processor 111 may search for a mapping table for a physical address corresponding to the read-requested logical address.

If the read-requested logical address is cached in a slot of the second buffer memory 119, the processor 111 may disregard the results of the search of the mapping table and enable the second buffer memory 119 to read data from the corresponding slot and to provide the read data to the host device through the host interface 113. If the read-requested logical address is not cached in the slot of the second buffer memory 119, the processor 111 may control the memory interface 115 based on a result of the search of the mapping table so that data read from the storage 120 is provided to the host device.

<Another Embodiment of Data Storage Device>

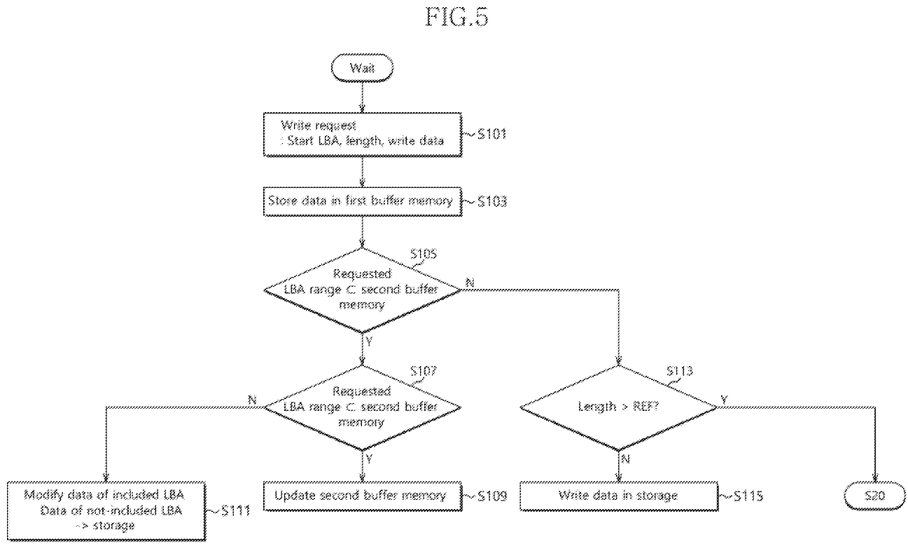

FIG. 4 illustrates a configuration of a data storage device according to an embodiment.

Referring to FIG. 4, a data storage device 10-1 according to an embodiment may include a controller 110-1 and a storage 120.

The controller 110-1 may control the storage 120 in response to a request from a host device. For example, the controller 110-1 may control data to be programmed into the storage 120 in response to a program (write) request from a host device. Furthermore, the controller 110-1 may provide a host device with data written in the storage 120 in response to a read request from the host device.

The storage 120 may write data or output written data under the control of the controller 110-1. The storage 120 may be configured with a volatile or non-volatile memory device. In an embodiment, the storage 120 may be implemented using any of various non-volatile memory devices, such as an electrically erasable and programmable ROM (EEPROM), a NAND flash memory, a NOR flash memory, a phase-change RAM (PRAM), a resistive RAM (ReRAM), a ferroelectric RAM (FRAM), and/or a spin torque transfer magnetic RAM (STT-MRAM). The storage 120 may include a plurality of dies, or a plurality of chips, or a plurality of packages. Furthermore, the storage 120 may be configured with single level cells, in each of which one bit of data is stored, or multi-level cells, in each of which multiple bits of data.

In an embodiment, the storage 120 may be configured with a memory device not supporting overwrite and/or in-place update, but is not limited thereto.

The controller 110-1 may include a processor 111, a host interface 113, a memory interface 115, a first buffer memory 117 and a second buffer memory 119.

That is, unlike in the data storage device 10 of FIG. 1, in the data storage device 10-1 of FIG. 4, the second buffer memory 119 is provided within the controller 110-1. The elements 111, 113, 115, and 117 of the controller 110-1 are the same or substantially similar as those of FIG. 1, and thus detailed description thereof is omitted here.

In an embodiment, the second buffer memory 119 may be implemented using a non-volatile memory device capable of overwrite and in-place update, such as a phase-change RAM (PRAM), a resistive RAM (ReRAM), a ferroelectric RAM (FRAM), and/or a spin torque transfer magnetic RAM (STT-MRAM).

<Operating Method of Data Storage Device: Write>

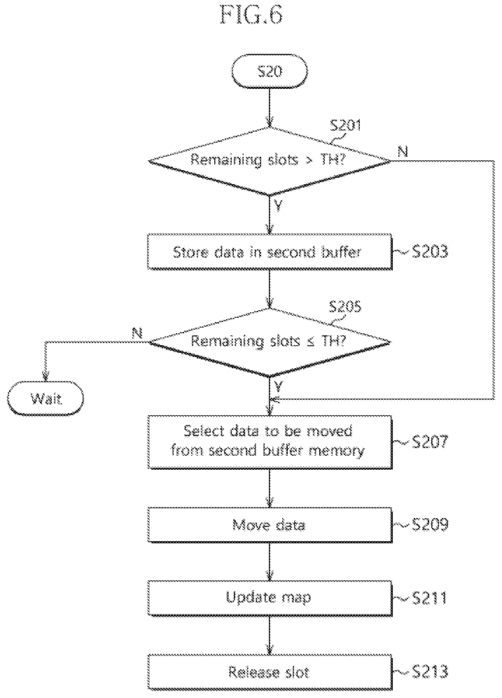

FIGS. 5 and 6 are flowcharts illustrating an operating method of the data storage device according to an embodiment.

Referring to FIG. 5, as a start logical address (LBA), a length and write data are provided to the data storage device 10 along with a write request from a host device (S101), the controller 110 controls the write data to be stored in the first buffer memory 117 (S103).

Furthermore, the controller 110 may identify whether a part of the logical address provided by the host device is included in logical addresses cached in a slot of the second buffer memory 119 (S105). If so (S105-Y), the controller 110 may check whether all the write-requested logical addresses indicated by the start logical address and the length are included in the logical address cached in the second buffer memory 119 (S107).

If all the write-requested logical addresses are cached in the second buffer memory 119 (S107-Y), the controller 110 may update the write data cached in the second buffer memory 119 by moving the write data from the first buffer memory 117 in the second buffer memory 119 (S109).

If only some of the write-requested logical addresses are cached in the second buffer memory 119 (S107-N), the controller 110 may control write data, having a logical address included in the logical addresses cached in the second buffer memory 119, to be moved from the first buffer memory 117 to the second buffer memory 119 so that the second buffer memory 119 is updated, and may program write data, corresponding to logical addresses not included in the logical addresses cached in the second buffer memory 119, in the storage 120 (S111).

If the write-requested logical addresses are not included in the logical addresses cached in the second buffer memory 119 (S105-N), the controller 110 may check whether the length of the write-requested data is greater than a reference value REF (S113). If, as a result of the check, the length of the write-requested data is less than or equal to the reference value REF, which indicates that the write-requested data is random write data (S113-N), the controller 110 may program the write data of the first buffer memory 117 into the storage 120 (S115).

If the length of the write-requested data is greater than the reference value REF, indicating that the write-requested data is sequential write data (S113-Y), the controller 110 may perform the process 520 of FIG. 6.

Referring to FIG. 6, the controller 110 may check whether the number of remaining slots within the second buffer memory 119 is greater than a threshold TH (S201).

If the number of remaining slots is greater than the threshold TH (S201-Y), the controller 110 may allocate a slot within the second buffer memory 119 and may control the write data to be cached in the allocated slot (S203). In this case, the start logical address LBA and length may also be cached in the allocated slot along with the write data.

Thereafter, the controller 110 may check whether the number of remaining slots within the second buffer memory 119 is less than or equal to the threshold TH (S205). If so (S205-Y), the controller 110 may perform a process of flushing the cached data from the second buffer memory 119 into the storage 120. In an embodiment, the controller 110 may select a slot satisfying a set condition, among slots within the second buffer memory 119 (S207), and may program data, cached in the selected slot, into the storage 120 (S209). As the data moves to the storage 120, the controller 110 may update a mapping table that correlates the logical address and a physical address within the storage 120 (S211), and may release the slot from which the data has been moved (S213).

In an embodiment, the controller 110 may select data to be moved based on the least recently used (LRU) algorithm or the number of times that write data has been changed, at step S207, but the present invention is not limited thereto.

If the number of remaining slots is greater than the threshold TH at step S205 (S205-N), the controller 110 may shift to a waiting state.

As described above, in this technology, random write data is stored in the storage 120 via the first buffer memory 117, and sequential write data is updated in response to a request from a host device in the state in which the sequential write data has been cached in the second buffer memory 119. Furthermore, data of sequential write data within the second buffer memory 119 and that has not been recently updated may be moved to the storage 120 because it is highly likely that such data will not be updated for a given period in the future. Accordingly, the continuity of a physical address for sequential write data stored in the storage 120 incapable of performing an overwrite operation and/or an in-place-update operation can be guaranteed.

<Operating Method of Data Storage Device: Read>

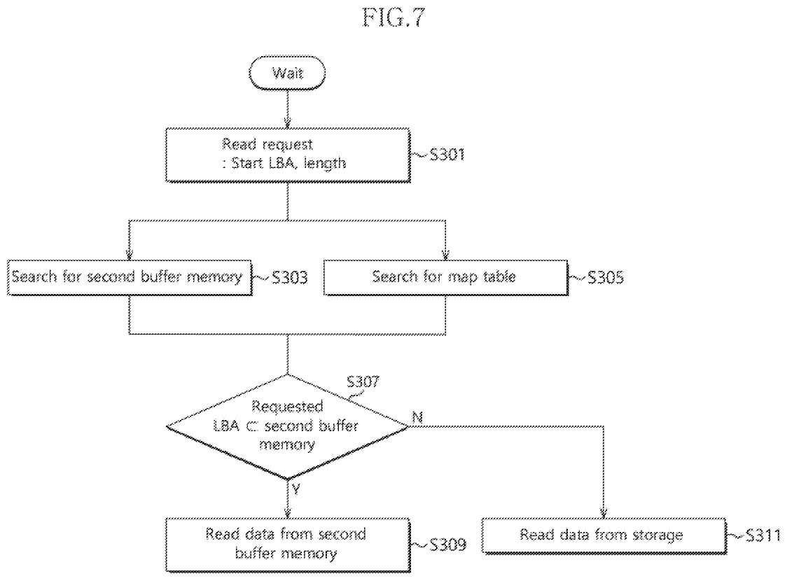

FIG. 7 is a flowchart for illustrating an operating method of the data storage device according to an embodiment.

As a host device transmits a start logical address and a length to the data storage device 10 along with a read request (S301), the controller 110 may search for the storage location of data corresponding to the read-requested logical address.

That is, the controller 110 may check whether the read-requested logical address is cached in a slot of the second buffer memory 119 (S303), and may also search from a map table for a physical address corresponding to the read-requested logical address (S305).

The controller 110 may check whether the read-requested logical address is included in logical addresses cached in the second buffer memory 119 (S307). If so (S307-Y), the controller 110 may read data from the second buffer memory 119 and provide the read data to the host device (S309).

If the read-requested logical address is not included in the logical address cached in the second buffer memory 119 (S307-N), the controller 110 may read data from the storage 120 and provide the read data to the host device through the first buffer memory 117 (S311).

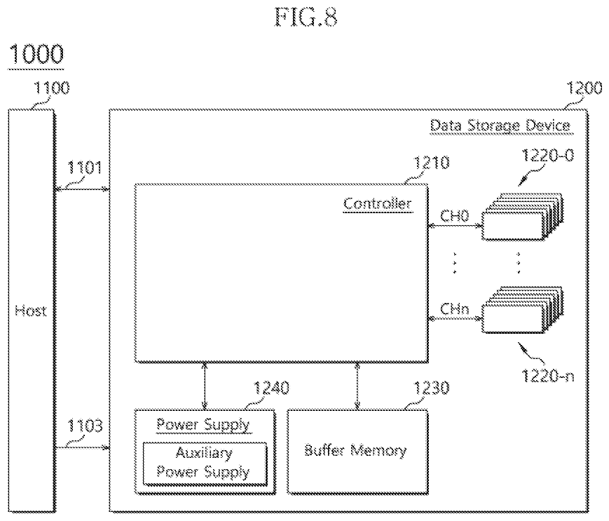

FIG. 8 is a diagram illustrating a data storage system 1000, in accordance with an embodiment.

Referring to FIG. 8, the data storage 1000 may include a host device 1100 and the data storage device 1200. In an embodiment, the data storage device 1200 may be configured as a solid state drive (SSD).

The data storage device 1200 may include a controller 1210, a plurality of nonvolatile memory devices 1220-0 to 1220-n, a buffer memory device 1230, a power supply 1240, a signal connector 1101, and a power connector 1103.

The controller 1210 may control general operations of the data storage device 1200. The controller 1210 may include a host interface, a controller, a random access memory used as a working memory, an error correction code (ECC) circuit, and a memory interface. In an embodiment, the controller 1210 may configured as controller 110 shown in FIG. 1, or FIG. 3 or FIG. 4.

The host device 1100 may exchange a signal with the data storage device 1200 through the signal connector 1101. The signal may include a command, an address, data, and the like.

The controller 1210 may analyze and process the signal received from the host device 1100. The controller 1210 may control operations of internal function blocks according to firmware or software for driving the data storage device 1200.

The buffer memory device 1230 may temporarily store data to be stored in at least one of the nonvolatile memory devices 1220-0 to 1220-n. Further, the buffer memory device 1230 may temporarily store the data read from at least one of the nonvolatile memory devices 1220-0 to 1220-n. The data temporarily stored in the buffer memory device 1230 may be transmitted to the host device 1100 or at least one of the nonvolatile memory devices 1220-0 to 1220-n according to control of the controller 1210.

The nonvolatile memory devices 1220-0 to 1220-n may be used as storage media of the data storage device 1200. The nonvolatile memory devices 1220-0 to 1220-n may be coupled with the controller 1210 through a plurality of channels CH0 to CHn, respectively. One or more nonvolatile memory devices may be coupled to one channel. The nonvolatile memory devices coupled to the same channel may be coupled to the same signal bus and data bus.

The power supply 1240 may provide power inputted through the power connector 1103 to the controller 1210, the nonvolatile memory devices 1220-0 to 1220-n and the buffer memory device 1230 of the data storage device 1200. The power supply 1240 may include an auxiliary power supply. The auxiliary power supply may supply power to allow the data storage device 1200 to be properly terminated when a sudden power interruption occurs. The auxiliary power supply may include bulk-capacity capacitors sufficient to store the needed charge.

The signal connector 1101 may be configured as one or more of various types of connectors depending on an interface scheme between the host device 1100 and the data storage device 1200.

The power connector 1103 may be configured as one or more of various types of connectors depending on a power supply scheme of the host device 1100.

FIG. 9 is a diagram illustrating a data storage system 1000-1, in accordance with an embodiment.

R Referring to FIG. 9, the data storage 1000-1 may include a host device 1100-1 and the data storage device 1200-1. In an embodiment, the data storage device 1200-1 may be configured as a solid state drive (SSD).

The data storage device 1200-1 may include a controller 1210, a plurality of nonvolatile memory devices 1220-0 to 1220-n, and a buffer memory 1250.

The controller 1210 may include a first buffer memory therein, thus the buffer memory 1250 may be referred as a second buffer memory.

The buffer memory 1250 is configured with a memory device supporting overwrite and/or in-place update, such as a phase-change RAM (PRAM), a resistive RAM (ReRAM), a ferroelectric RAM (FRAM), and/or a spin torque transfer magnetic RAM (STT-MRAM).

The controller 1210 may control general operations of the data storage device 1200-1 and the data storage device 1200-1. The controller 1210 may include a host interface, a controller, a random access memory used as a working memory, an error correction code (ECC) circuit, and a memory interface. In an embodiment, the controller 1210 may configured as controller 110 shown in FIG. 1 or FIG. 3 or FIG. 4.

The host device 1100-1 may exchange a signal with the data storage device 1200-1 through the signal connector 1101. The signal may include a command, an address, data, and the like.

The controller 1210 may analyze and process the signal received from the host device 1100-1. The controller 1210 may control operations of internal function blocks according to firmware or software for driving the data storage device 1200-1.

The first buffer memory embedded in the controller 1210 may temporarily store data to be stored in at least one of the nonvolatile memory devices 1220-0 to 1220-n. Further, the first buffer memory may temporarily store the data read from at least one of the nonvolatile memory devices 1220-0 to 1220-n. The data temporarily stored in the first buffer memory may be transmitted to the host device 1100-1 or at least one of the nonvolatile memory devices 1220-0 to 1220-n according to control of the controller 1210 during a read operation. The data temporarily stored in the first buffer memory may be transmitted to at least one of the nonvolatile memory devices 1220-0 to 1220-n or the buffer memory 1250 as the second buffer memory according to control of the controller 1210 during a write operation.

The nonvolatile memory devices 1220-0 to 1220-n may be used as storage media of the data storage device 1200-1. The nonvolatile memory devices 1220-0 to 1220-n may be coupled with the controller 1210 through a plurality of channels CH0 to CHn, respectively. One or more nonvolatile memory devices may be coupled to one channel. The nonvolatile memory devices coupled to the same channel may be coupled to the same signal bus and data bus.

The signal connector 1101 may be configured as one or more of various types of connectors depending on an interface scheme between the host device 1100-1 and the data storage device 1200-1.

The power connector 1103 may be configured as one or more of various types of connectors depending on a power supply scheme of the host device 1100-1.

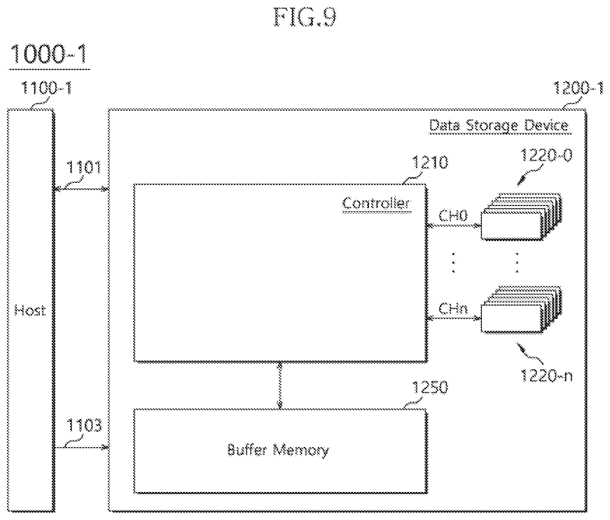

FIG. 10 is a diagram illustrating a data processing system 3000, in accordance with an embodiment. Referring to FIG. 10, the data processing system 3000 may include a host device 3100 and a memory system 3200.

The host device 3100 may be configured in the form of a board, such as a printed circuit board. Although not shown, the host device 3100 may include internal function blocks for performing the function of a host device.

The host device 3100 may include a connection terminal 3110, such as a socket, a slot, or a connector. The memory system 3200 may be mated to the connection terminal 3110.

The memory system 3200 may be configured in the form of a board, such as a printed circuit board. The memory system 3200 may be referred to as a memory module or a memory card. The memory system 3200 may include a controller 3210, a buffer memory device 3220, nonvolatile memory devices 3231 and 3232, a power management integrated circuit (PMIC) 3240, and a connection terminal 3250.

The controller 3210 may control general operations of the memory system 3200. The controller 3210 may be configured in the same manner as the controller 110 shown in FIGS. 1 and 2.

The buffer memory device 3220 may temporarily store data to be stored in the nonvolatile memory devices 3231 and 3232. Further, the buffer memory device 3220 may temporarily store data read from the nonvolatile memory devices 3231 and 3232. The data temporarily stored in the buffer memory device 3220 may be transmitted to the host device 3100 or the nonvolatile memory devices 3231 and 3232 according to control of the controller 3210.

The nonvolatile memory devices 3231 and 3232 may be used as storage media of the memory system 3200.

The PMIC 3240 may provide the power inputted through the connection terminal 3250 to the inside of the memory system 3200. The PMIC 3240 may manage the power of the memory system 3200 according to control of the controller 3210.

The connection terminal 3250 may be coupled to the connection terminal 3110 of the host device 3100. Through the connection terminal 3250, signals such as commands, addresses, data, and the like, and power may be transferred between the host device 3100 and the memory system 3200. The connection terminal 3250 may be configured as one or more of various types depending on an interface scheme between the host device 3100 and the memory system 3200. The connection terminal 3250 may be disposed on a side of the memory system 3200, as shown.

FIG. 11 is a diagram illustrating a data processing system 4000 in accordance with an embodiment. Referring to FIG. 11, the data processing system 4000 may include a host device 4100 and a memory system 4200.

The host device 4100 may be configured in the form of a board, such as a printed circuit board. Although not shown, the host device 4100 may include internal function blocks for performing the function of a host device.

The memory system 4200 may be configured in the form of a surface-mounted type package. The memory system 4200 may be mounted to the host device 4100 through solder balls 4250. The memory system 4200 may include a controller 4210, a buffer memory device 4220, and a nonvolatile memory device 4230.

The controller 4210 may control general operations of the memory system 4200. The controller 4210 may be configured in the same manner as the controller 110 shown in FIGS. 1 and 2.

The buffer memory device 4220 may temporarily store data to be stored in the nonvolatile memory device 4230. Further, the buffer memory device 4220 may temporarily store data read from the nonvolatile memory device 4230. The data temporarily stored in the buffer memory device 4220 may be transmitted to the host device 4100 or the nonvolatile memory device 4230 according to control of the controller 4210.

The nonvolatile memory device 4230 may be used as the storage medium of the memory system 4200.

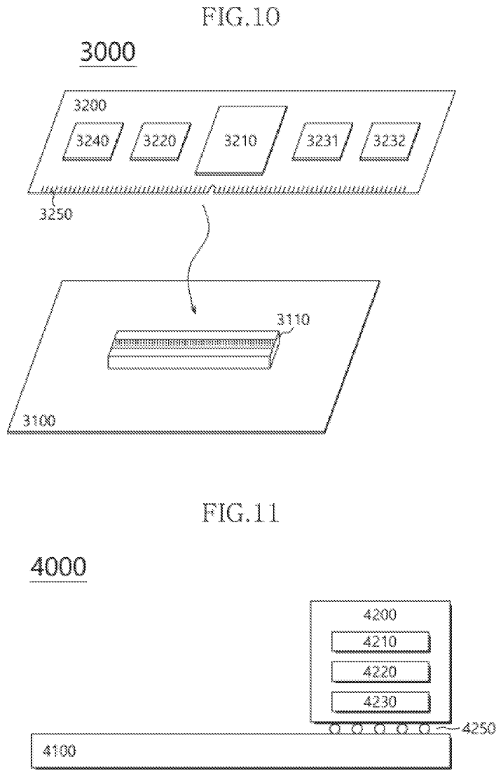

FIG. 12 is a diagram illustrating a network system 5000 including a data storage device, in accordance with an embodiment. Referring to FIG. 12, the network system 5000 may include a server system 5300 and a plurality of client systems 5410, 5420, and 5430, which are coupled through a network 5500.

The server system 5300 may service data in response to requests from the plurality of client systems 5410 to 5430. For example, the server system 5300 may store the data provided by the plurality of client systems 5410 to 5430. For another example, the server system 5300 may provide data to the plurality of client systems 5410 to 5430.

The server system 5300 may include a host device 5100 and a memory system 5200. The memory system 5200 may be configured as the memory system 10 shown in FIG. 1, the data storage device 1200 shown in FIG. 8, the memory system 3200 shown in FIG. 10, or the memory system 4200 shown in FIG. 11.

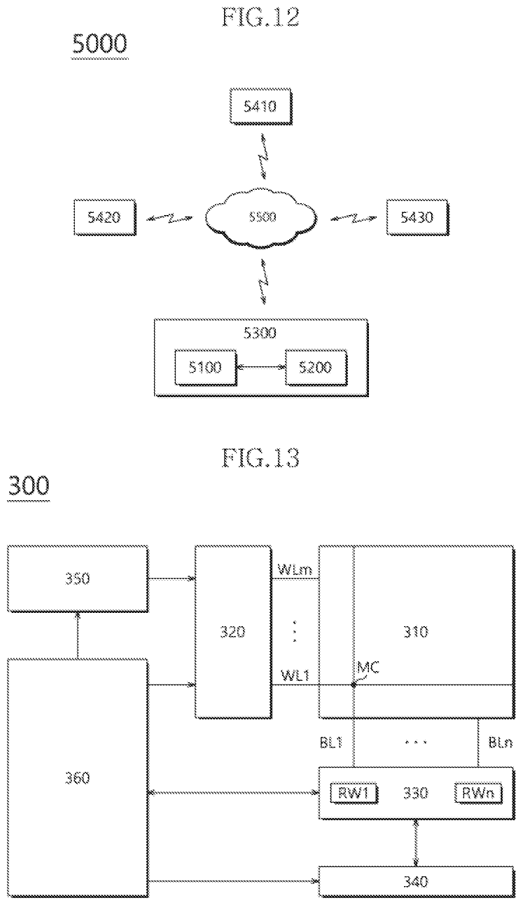

FIG. 13 is a block diagram illustrating a nonvolatile memory device 300 included in a data storage device, such as the data storage device 120, in accordance with an embodiment. Referring to FIG. 13, the nonvolatile memory device 300 may include a memory cell array 310, a row decoder 320, a data read/write block 330, a column decoder 340, a voltage generator 350, and control logic 360.

The memory cell array 310 may include memory cells MC which are arranged at areas where word lines WL1 to WLm and bit lines BL1 to BLn intersect with each other.

The memory cell array 310 may comprise a three-dimensional memory array. The three-dimensional memory array, for example, has a stacked structure extending in a perpendicular direction to the flat surface of a semiconductor substrate. Moreover, the three-dimensional memory array means a structure including NAND strings of which memory cells are stacked perpendicular to the flat surface of a semiconductor substrate.

The structure of the three-dimensional memory array is not limited to the embodiment indicated above. The memory array structure can be formed in a highly integrated manner with horizontal directionality as well as vertical directionality. In an embodiment, in the NAND strings of the three-dimensional memory array, memory cells are arranged parallel and perpendicular to the surface of the semiconductor substrate. The memory cells may be variously spaced to provide different degrees of integration.

The row decoder 320 may be coupled with the memory cell array 310 through the word lines WL1 to WLm. The row decoder 320 may operate according to control of the control logic 360. The row decoder 320 may decode an address provided by an external device (not shown). The row decoder 320 may select and drive the word lines WL1 to WLm, based on a decoding result. For instance, the row decoder 320 may provide a word line voltage, provided by the voltage generator 350, to the word lines WL1 to WLm.

The data read/write block 330 may be coupled with the memory cell array 310 through the bit lines BL1 to BLn. The data read/write block 330 may include read/write circuits RW1 to RWn, respectively, corresponding to the bit lines BL1 to BLn. The data read/write block 330 may operate according to control of the control logic 360. The data read/write block 330 may operate as a write driver or a sense amplifier, according to an operation mode. For example, the data read/write block 330 may operate as a write driver, which stores data provided by the external device in the memory cell array 310 in a write operation. For another example, the data read/write block 330 may operate as a sense amplifier, which reads out data from the memory cell array 310 in a read operation.

The column decoder 340 may operate according to control of the control logic 360. The column decoder 340 may decode an address provided by the external device. The column decoder 340 may couple the read/write circuits RW1 to RWn of the data read/write block 330, respectively corresponding to the bit lines BL1 to BLn, with data input/output lines or data input/output buffers, based on a decoding result.

The voltage generator 350 may generate voltages to be used in internal operations of the nonvolatile memory device 300. The voltages generated by the voltage generator 350 may be applied to the memory cells of the memory cell array 310. For example, a program voltage generated in a program operation may be applied to a word line of memory cells for which the program operation is to be performed. For another example, an erase voltage generated in an erase operation may be applied to a well area of memory cells for which the erase operation is to be performed. For still another example, a read voltage generated in a read operation may be applied to a word line of memory cells for which the read operation is to be performed.

The control logic 360 may control general operations of the nonvolatile memory device 300, based on control signals provided by the external device. For example, the control logic 360 may control operations of the nonvolatile memory device 300 such as read, write, and erase operations of the nonvolatile memory device 300.

While various embodiments have been illustrated and described, it will be understood to those skilled in the art in light of the present disclosure that the embodiments described are examples only. Accordingly, the present invention is not limited to or by the described embodiments. Rather, the present invention encompasses all modifications and variations of such embodiments that fall within the scope of the claims and their equivalents.

What is claimed is:

1. A data storage device comprising:
a storage;
a controller configured to control data input to, and output from, the storage in response to a request from a host device; and
a second buffer memory,
wherein the controller comprises a first buffer memory, and is configured to:
store write data, provided by the host device, in the first buffer memory in response to a write request of the host device, and
move the write data, stored in the first buffer memory, into the second buffer memory or the storage based on an attribute of the write data.

2. The data storage device according to claim 1, wherein the attribute includes a length of the write data or a logical address of the write data.

3. The data storage device according to claim 2, wherein when the length of the write data is less than a reference length, the controller is configured to move the write data from the first buffer memory to the storage.

4. The data storage device according to claim 2, wherein, when the length of the write data is greater than the reference length, the controller is configured to move the write data from the first buffer memory to the second buffer memory.

5. The data storage device according to claim 1, wherein the second buffer memory comprises a non-volatile memory device capable of overwrite or an in-place update.

6. The data storage device according to claim 1, wherein the controller is configured to move the write data that satisfies a set condition from the second buffer memory into the storage.

7. The data storage device according to claim 6, wherein the controller is configured to move the write data from the second buffer memory into the storage according to a least recently used (LRU) scheme or number of times that the write data has been changed.

8. The data storage device according to claim 1, wherein the controller is configured to:
allocate one of a plurality of slots within the second buffer memory,
move the write data from the first buffer memory into the allocated slot, and
move the write data satisfying a set condition into the storage from the second buffer memory when a number of empty slots, among the plurality of slots, is less than or equal to a set threshold.

9. The data storage device according to claim 8, wherein the controller is configured to:
select, as the allocated slot, any one of the plurality of slots according to a least recently used (LRU) scheme or the number of times that the write data has been changed, and
move the write data of the allocated slot into the storage.

10. The data storage device according to claim 1,
wherein the second buffer memory caches address information of a start logical address and length corresponding to the write data moved therein, and
wherein the controller is configured to move the write data from the first buffer memory into the second buffer memory when all write-requested logical addresses corresponding to the write data stored in the first buffer memory are included in the address information.

11. The data storage device according to claim 1,
wherein the second buffer memory caches address information of a start logical address and length corresponding to the write data moved therein, and
wherein, when a first group of write-requested logical addresses corresponding to the write data stored in the first buffer memory are included in the address information and a second group of the write-requested logical addresses are not included in the address information, the controller is configured to:
move the write data of the first group from the first buffer memory into the second buffer memory; and
move the write data of the second group from the first buffer memory into the storage.

12. The data storage device according to claim 1, wherein the second buffer memory is provided within the controller.

13. An operating method of a data storage device comprising a storage, a second buffer memory, a controller controlling data input to, and output from, the storage in response to a request from a host device, and a first buffer memory, the operating method comprising:
storing, by the controller, write data, provided by the host device, in the first buffer memory in response to a write request of the host device, and
moving, by the controller, the write data, stored in the first buffer memory, into the second buffer memory or the storage based on an attribute of the write data.

14. The operating method according to claim 13, wherein the attribute includes a length of the write data or a logical address of the write data.

15. The operating method according to claim 14, further comprising moving, by the controller, the write data from the first buffer memory to the storage when the length of the write data is less than a reference length.

16. The operating method according to claim 14, further comprising moving, by the controller, the write data from the first buffer memory to the second buffer memory when the length of the write data is greater than a reference length.

17. The operating method according to claim 13, further comprising moving, by the controller, the write data that satisfies a set condition from the second buffer memory into the storage.

18. The operating method according to claim 17, wherein the write data is moved from the second buffer memory to the storage according to a least recently used (LRU) scheme or number of times that the write data has been changed.

19. The operating method according to claim 13,
further comprising caching, by the controller, address information of a start logical address and length corresponding to the write data moved into the second buffer memory,
wherein the moving of the write data includes moving the write data from the first buffer memory into the second buffer memory when all write-requested logical addresses corresponding to the write data stored in the first buffer memory are included in the address information.

20. The operating method according to claim 13,
further comprising caching, by the controller, address information of a start logical address and length corresponding to the write data moved into the second buffer memory,
wherein, when a first group of write-requested logical addresses corresponding to the write data stored in the first buffer memory are included in the address information and a second group of the write-requested logical addresses are not included in the address information, the moving of the write data includes:
moving the write data of the first group from the first buffer memory into the second buffer memory; and
moving the write data of the second group from the first buffer memory into the storage.
